(19) United States
(12) Patent Application Publication
(10) Pub. No.: US 2004/0128305 A1
(43) Pub. Date: Jul. 1, 2004

(54) Data consolidation component for integration of heterogeneous sources of control events

(75) Inventors: Yuri Levin, Naharia (IL); Vladimir Shcherbina, Nesher (IL)

Correspondence Address: Stephen C. Kaufman, Intellectual Property Law Dept., IBM Corporation, P.O. Box 218, Yorktown Heights, NY, 10598, US

(73) Assignee: International Business Machines Corporation, Armonk, NY (US)

(21) Appl. No.: 10/331,437

(22) Filed: Dec. 27, 2002

(51) Int. Cl. G06F 7/00

(52) U.S. Cl. 707/102; 705/1; 340/870.01

(57) ABSTRACT

A system for providing services for gathering data in an event driven environment. Upon occurrence of one or more events in an event source, the system includes means for receiving the events in a event repository and means for transmitting an event message to a data warehouse. Upon receipt of the events in the event repository, the system includes means for activating an event activator, the event activator for causing an event transmitter to transmit the event message. The system further includes means for evaluating search conditions; and means for causing, when the search conditions are true, the event transmitter to transmit the event message.

### FIELD OF INVENTION

The present invention relates to event driven environments in general, and particularly to data gathering in event driven environments.

### BACKGROUND

E-business and virtual enterprises have become commonplace. A typical virtual enterprise may be characterized by collaboration of multiple corporations. Each of the multiple corporations may comprise an information technology (IT) system, a software management system (SMS), and management policies. Information may be transferred between the multiple IT systems and SMSs of the virtual enterprise. However, the multiple IT systems and SMSs may not be compatible. Hence, it is sometimes a Herculean task to combine all the systems into a harmonious, virtual enterprise system.

To meet this need, business management systems (BMS) evolved. Among other capabilities, BMSs are able to receive events from many different types of media, in multiple formats. Another new technological area is e-Business Management (eBM). In the evolving e-Business market, electronic Business Management Systems (eBMS) monitor business processes and corresponding technological processes. In some instances, eBMSs may monitor either a virtual enterprise or a mega-corporation. The mega-corporation may comprise multiple entities, each with its own IT system and SMS. In many instances, the eBMS has very limited, if any, corporate-wide management system.

In such an environment, in order to gather event data, the eBMS must retrieve a vast number of control events through the various, vendor-specific application programming interfaces (API) used by each corporation or entity. Alternatively, the eBMS must connect to all the event tables and databases of each company. In some instances, the event tables or databases may not even exist. Either option is not optimal.

Regardless of the difficulty, the job of the eBMS is retrieve event data, on-demand, in its native format, from each organization. The eBMS must then transform the event data into a predefined canonical format.

One possible solution to the event gathering and processing task is to provide adapter interfaces for each company or event source. However, for this solution, customized adapting code must be developed for each new customer. Moreover, in order to sync the central data warehouse with the event sources, the databases must be periodical polled. Typically, periodic polling is difficult to maintain.

It is therefore desirable to provide method and apparatus to support event data retrieval on-demand in environments such as virtual corporations and mega-corporations.

### SUMMARY

The present invention provides a simplified approach to gathering control events information from different SMSs. One aspect of the present invention provides for storing event data in a common central database.

An additional aspect of the present invention provides an event triggering system. The event triggering system may comprise a database subscription mechanism. The subscription mechanism may select events of interest. When the events of interest occur, they trigger sending of an event message.

The event triggering system may collect events from all aspects of a virtual enterprise into the central repository. Thus, a preferred embodiment of the present invention assists in integrating an Internet based virtual enterprise with multiple businesses and multiple IT platforms. The present invention endeavors to establish an improved infrastructure for virtual enterprises.

The present invention provides a unified architectural approach to data and event gathering from heterogeneous sources of control events.

According to one embodiment of the present invention, there is therefore provided a system for data gathering. The system includes a plurality of event sources, each the event source includes an event repository and an event transmitter. Upon occurrence of an event, the event repository receives the events. The event transmitter transmits an event message to a data warehouse. An event activator is activated when the event repository receives the events, and causes the event transmitter to transmit the event message.

The event activator may further include a trigger that evaluates search conditions. When the search conditions are true, a user-defined function causes the event transmitter to transmit the event. A subscriber, communicates to the event activator one or more subscriber selectors; the selectors may be the basis for the search conditions.

The event source include a software management system that inserts the events to the event repository. In some embodiments, the data warehouse includes an event consolidator. The event consolidator receives the events from the event transmitter, consolidates the events, identifies one or more events of interest, and allows the events of interest to be transmitted to the data warehouse.

According to another embodiment of the present invention, there is therefore provided a additional system for data gathering. The system includes a common data warehouse and a plurality of event sources. The event source includes an event repository, an event transmitter and an event activator. The event activator includes a trigger and a user-defined function. The user-defined function is adapted to implement message oriented middleware (MOM) publisher interface, thereby publishing the messages.

According to one embodiment of the present invention, there is therefore provided a method for gathering data in a event driven environment. The method includes the steps of, upon occurrence of an event in an event source, receiving the events in a event repository and transmitting an event message to a data warehouse. The method also includes, upon the receiving of the events in the event repository, activating an event activator for causing an event transmitter to transmit the event message. The method may additionally includes the steps of evaluating search conditions; and, when the search conditions are true, causing the event transmitter to transmit the event message. Further steps may be communicating to the event activator one or more subscriber selectors, the subscriber selectors to be a basis for search conditions.

In some embodiments, the method includes receiving in a consolidator the events from the event transmitter; consolidating the events; identifying one or more events of interest; and allowing the events of interest to be transmitted to a data warehouse.

According to one embodiment of the present invention, there is therefore provided a computer program embodied on a computer-readable medium. The computer program includes a first code segment for receiving one or more events in an event repository. A second code segment is for transmitting an event message to a data warehouse. A third code segment, upon receipt of the event in the event repository, causes the transmission of the message. A fourth code segment is for evaluating search conditions. When the search conditions are true, a fifth code segment causes an event transmitter to transmit the event message.

According to one embodiment of the present invention, there is therefore provided a method for providing data gathering services in a event driven environment. Upon occurrence of an event in an event source, the method includes receiving the events in a event repository and transmitting an event message to a data warehouse. Upon receipt of the events in the event repository, the service includes activating an event activator for causing an event transmitter to transmit the event message.

The method may further providing services to evaluate search conditions, and when the search conditions are true, causing the event transmitter to transmit the event message.

According to one embodiment of the present invention, there is therefore provided a system for providing services for gathering data in a event driven environment. Upon occurrence of one or more events in an event source, the system includes means for receiving the events in a event repository and means for transmitting an event message to a data warehouse.

The system may further include means for activating, upon receipt of the events in the event repository, an event activator for causing an event transmitter to transmit the event message. The system further includes means for evaluating search conditions; and means for causing, when the search conditions are true, the event transmitter to transmit the event message.

### BRIEF DESCRIPTION

Embodiment of the invention will now be described, by way of example, with reference to the accompanying drawings, in which:

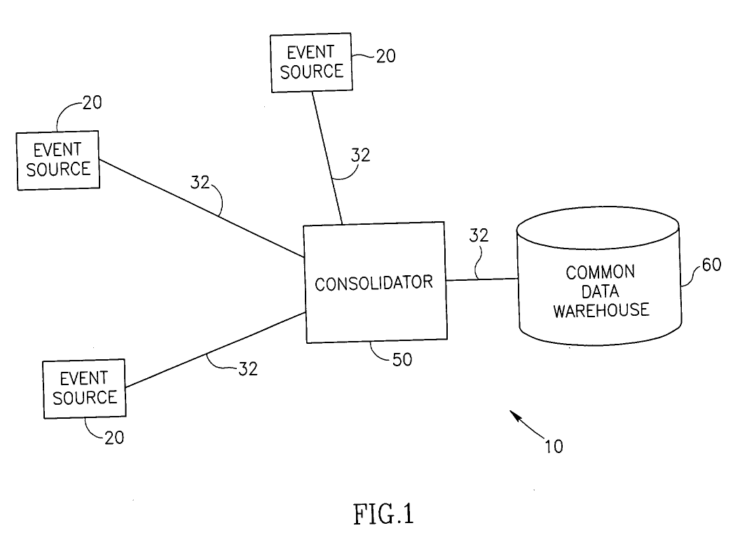

FIG. 1 is a block diagram of a data system 10 usable in an event driven environment, operated and constructed according to an embodiment of the present invention;

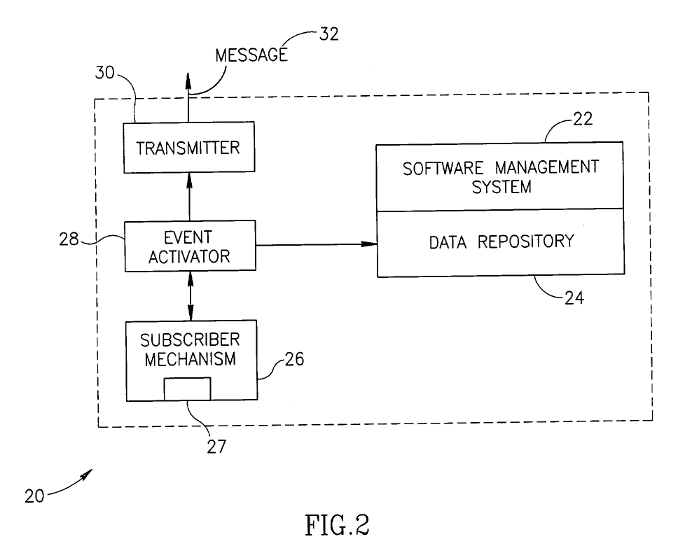

FIG. 2 is an illustration of an event source 20, constructed and operated according to on aspect of the invention; and

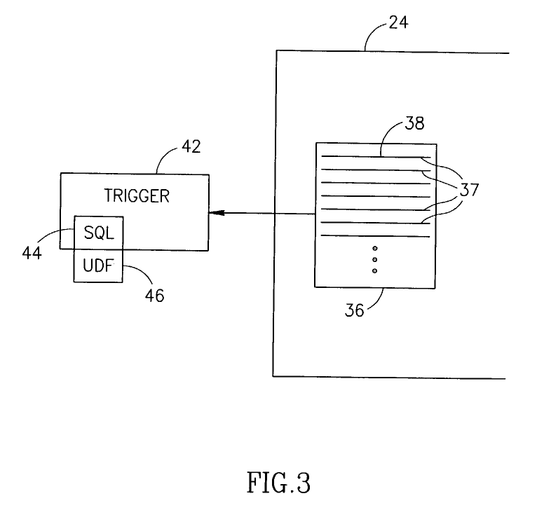

FIG. 3 is a conceptual illustration of trigger, constructed and operated according to one aspect of the present invention

### DETAILED DESCRIPTION

Reference is now made to FIG. 1, an illustration of a data system 10 usable in an event driven environment such as a e-business management system (eBMS). System 10 may gather and consolidate events from a virtual enterprise or a corporation's Intranet. System 10 typically comprises one or more event sources 20 and a common data warehouse 60.

In a preferred embodiment, each event source 20 may be in communication with common data warehouse 60. In some embodiments, event sources 20 are a collection of heterogeneous sources such as system management software (SMS), databases, organizations, business processes, vendor specific applications, etc.

Upon occurrence of an event at one of the event sources 20, the affected event source 20 is triggered to transmit an event message 32. Event message 32 may comprise information pertaining to event time, event type, initiator of the event, etc., depending on the event format. The events messages may be supplied to on-demand, or upon their occurrence at the various event sources 20.

In some embodiments, each of the event sources 20 may use a common event format. Alternatively, each event source 20 may use a different event format. Event format may be a set of event characteristics, such as event source, event type, event initiator, time, etc. Generally speaking, the different event formats may be both syntactically and semantically different.

Event message 32 may be transferred to a consolidator 50. Consolidator 50 filters event messages 32. Consolidator 50 eliminates some of the event messages 32 and transmits the other event messages 32 to common data warehouse 60.

In some embodiments, system 10 may be implemented without consolidator 50. In other embodiments, common data warehouse 60 may comprises event consolidator 50.

In the above manner, data warehouse 60 effectively collects event information from the multiple heterogeneous event sources 20. It is noted that while prior art systems relied upon unreliable polling, or pull technology, the present invention describes an event-push system.

Alternative embodiments of the present invention provide event triggering and an extension thereto, using user-defined functions. Yet other alternative embodiments may comprise a publish/subscribe mechanism for publishing events. Yet other embodiments may comprise subscribers for subscribing to certain types of events. Each of these embodiments will be described in detail hereinbelow.

Reference is now made to FIG. 2, an illustration of an event source 20, constructed and operated according to one aspect of the present invention. Each event source 20 may comprise a software management system (SMS) 22, an event repository 24, an event subscriber 26, an event activator 28, and an event transmitter 30.

SMS 22 manages the execution of hardware devices and IT processes, such as applications, operational systems and networks. The IT processes may typically be performed in a distributed environment. Examples of SMS 22 include Tivoli TEC and BMC PATROL. Events may be registered in SMS 22. The events may comprise addition of a data, deletion of data, or amendment of data.

As an example, if event source 20 is a stock brokerage, SMS 22 may track the value of the stocks, or other events. Alternatively, if event source 20 is a hospital, SMS 22 may track patients and events related thereto.

Upon registration of an event, SMS 22 may write, erase, and/or update an event record to event repository 24. Event repository 24 receives and stores the event record for each event. Alternatively, event repository 24 stores the event record only for predetermined relevant events. Via record of all relevant events, event repository 24 captures the execution history of an associated IT process.

Referring to the example above, if event source 20 is a hospital and SMS 22 is tracking patient histories, event repository 24 receives and stores the event records relevant to the hospitalization of patients. Alternatively, SMS 22 may be managing the pharmacy, and event repository 24 stores event records relating to supply and usage of medicines.

In some instances, event repository 24 may be stored in a relational database (not shown). In other embodiments, event repository 24 may be optional; SMS 22 may write the event records directly into the relational database. In other alternative embodiments, SMS 22 may not write the event record. Rather, other mechanisms may be responsible for writing the event record.

Below is an example of data that may be available in an event record.

Timestamp: Date and time the event took place.

Event Type: Type of the event that caused the event record to be written. Typical events may comprise the start of a process, termination of a process, abnormal termination of a process, or a process alert. Another exemplary event may be the start or termination of an application. In some embodiments, any type of event occurring during the execution of a process may generate an event record.

Event Instance Identifier: Identification of the event instance. Each event instance may be uniquely identified via its associated identifier. An exemplary event instance may be:

“20-Nov-02 12:44:36 AM DB2JDS Information None 2402 TP-SHCHERB JDBCService: JDBC Applet Server started”.

Event Originator Identifier: Uniquely identifies the object that is the original source of the event. The object may be a network device, a user, or the process instance. SMS 22 may use the event originator identifier to access the object.

Event Register Identifier: Uniquely identifies the software process that registers the event. Examples of such software processes include Windows Event Source, which runs as a Windows service on a PC and registers application events in the Windows event log.

Event Register Type: Type of the SMS that is used for initial event registration.

Event Description: The event description in free text format.

Severity: Rank of event severity, from critical alerts to informational.

Event activator 28 is in communication with event repository 24. When an event is received by event repository 24, event activator 28 is activated. Once activated, event activator 28 may query the truth of search conditions.

In a preferred embodiment, event activator 28 is a database trigger 42 extended with a database user-defined function 46 (FIG. 3). Further details of database trigger 42 and user-defined function 46 will be explained hereinbelow in reference to FIG. 3.

Event activator 28 receives the search conditions from subscriber 26. Subscriber 26 may hold a set of filtering conditions, or logical expressions, known herein as subscriber selectors 27. As an example, selector 27 may be; ‘event severity>3’.

Selectors 27 may be predefined or selected by the administrator of system 10, or any other user. In alternative embodiments, SMS 22 may select selectors 27. The selection of selectors 27 may be based on the business needs of the corporation. As an example, if the corporation is a stock brokerage firm, selectors 27 may be: ‘name of company=IBM’.

Subscriber 26 communicates selectors 27 to event activator 28. In preferred embodiments, event activator 28 specifies selectors 27 as one or more search conditions.

Whenever an event record is written, erased, and/or updated in data repository 24, event activator 28 may be activated. Event activator 28 may then evaluate the new event record to see if it meets the one or more search conditions. When one or more of the search conditions are met, the new event is sent to transmitter 30.

As an example, a selector 27 may be; ‘item to follow=stock of IBM’. At a later time, an event may be sent to data repository 24. The event may be an increase in a stock price. When the event record is updated, event activator 28 may be activated.

Event activator 28 queries the event record to see if it is IBM stock or not i.e. if the search condition is met. In a preferred embodiment of the present invention, upon occurrence of a selector 27, e.g. if the search condition is met, event activator 28 transfers event message 32 to event transmitter 30. Event transmitter 30 then transfer event message 32 to event consolidator 50.

Transmitter 30 may transfer event message 32 via a standard message protocol implemented by some message oriented middleware (MOM). An example of MOM is IBM's MQSeries and its implementation of Sun's Java Messaging System (JMS) specification. It is apparent to those skilled in the art that other MOMs and/or messaging protocols may be used, and still be in the spirit of the present invention.

Thus, as explained above, while prior art depending on potentially unreliable event polling, the present invention provides an event-driven or push system.

It is noted that in preferred embodiments, each event source 20 functions independently of the other event sources 20. As noted, event sources 20 are event driven, and hence they do not need to wait for a polling center to retrieve the events. Consequently, each event source 20 may supply their respective event messages 32 without interference or dependence on the other event sources 20.

Reference is now made to FIG. 3, a conceptual illustration of trigger 42. Relational database management systems may provide triggers. However, trigger 42 of the present invention may also be extended to be implemented with user defined functions 46. It is noted that prior art triggers do not comprise, or are not extended to user-defined functions 46.

Database triggers 42 and user-defined functions 46 will now be explained. Trigger 42 may define a set of actions that are to be executed, or triggered, by a certain event 38. Events 38 may take place in a table 36. Examples of events 38 include ‘delete’, ‘insert’, or ‘update’ operations. These events 38 may cause a “trigger”. When such an operation is executed, trigger 42 is said to be “activated”.

Triggers 42 may be defined using a “CREATE TRIGGER” statement. CREATE TRIGGER statements may comprise the criteria. Examples of such criteria are following:

Trigger event 38 or specific SQL operation. The operation may be ‘delete’, ‘insert’, or ‘update’.

Subject table 36 for which the trigger is defined. As an example, the “expense” table or the “log-in” table. In preferred embodiments, subject table 36 may be in data repository 24 (FIG. 2).

Thus, when the trigger event 38 occurs at, or to, subject table 36, trigger 42 is activated. Trigger 42 may be activated after trigger event 38 is performed on subject table 36.

As an example, trigger event 38 may be “insert”, subject table 36 may be “log-in” table. Thus, when an “insert” event 38 occurs in the “log-in” table 36, trigger 42 is activated.

Once the criteria (trigger event 38, trigger table 36, etc.) are fulfilled, trigger 42 is activated. The triggered action comprises a set of structured query language (SQL) statements 44 and one or more search conditions, i.e. subscription selections 27.

SQL statements 44 are executed only when two conditions are met: both trigger 42 is activated and the search condition(s) is true. Thus, if trigger 42 is activated, however, the search condition is false, then the SQL statements 44 is not executed.

In an embodiment of the present invention, once the search condition is met, event activator 28 sends event message 32 to event transmitter 30.

It is herein noted that in prior art triggers, it is only possible to query search conditions. Prior art triggers do not send messages or notifications.

In preferred embodiments of the present invention, trigger 42 may be extended to comprise user function 46. User function 46 implements a notification mechanism (not shown) that sends event message 32 to event transmitter 30.

User-defined functions 46 may be functions registered in a database. User-defined functions 46 may be used via database functions and during regular database processing.

In some embodiments, user-defined functions 46 offer internal or external database processing. User-defined function 46 may be external or sourced.

Vendors of other relational database management systems may use a different term for user-defined function 46, however, provide the same function, and still be included within the true spirit and concept of the present invention.

While the present invention has been described with reference to one or more specific embodiments, the description is intended to be illustrative of the invention as a whole, and is not to be construed as limiting the invention to the embodiments shown.

In other alternative embodiments, data repository 24, event activator 28 and subscriber 26 may be part of a relational database (not shown). The relational database may be managed by a relational database management system. A relational database management system may evaluates the search condition.

As a further example, event source 20 may be implemented on top of any SMS 22. Nevertheless, in some alternative embodiments, SMS 22 may be optional. In such instances, event source 20 may be implemented on top of an event generating software.

An a further example of alternative embodiments, rather than comprise data repository 24, event source 20 may communicate with an external data repository. As yet another example, though the present description is based on a relational database system, alternative embodiments may be based on other database system supported by database triggers.

It is appreciated that those skilled in the art that may be aware of various other modifications, which while not specifically shown herein, are nevertheless within the true spirit and scope of the invention.

While the method and apparatus disclosed herein may of may not have been described with reference to specific computer hardware of software, it is appreciated that the methods and apparatus described herein may be readily implemented in computer hardware of software using conventional techniques.

1. A system for data gathering, the system comprising
a plurality of event sources, each said event source comprising
an event repository, upon occurrence of an event, said event repository for receiving said events; and
an event transmitter for transmitting an event message to a data warehouse.

2. The system of claim 1, and further comprising:
an event activator adapted to be activated upon said receiving of said events and to cause said event transmitter to transmit said event message.

3. The system of claim 2, wherein said event activator comprises
a trigger for evaluating search conditions; and
a user-defined function for causing said event transmitter to transmit said event when said search conditions are true.

4. The system of claim 2, and further comprising a subscriber for communicating to said event activator one or more subscriber selectors, said subscriber selectors to be a basis for search conditions.

5. The system of claim 1, wherein said event source comprises a software management system for inserting said events to said event repository.

6. The system of claim 1, wherein said data warehouse comprises an event consolidator for receiving said events from said event transmitter and for consolidating said events, identifying one or more events of interest, and allowing said events of interest to be transmitted to said data warehouse.

7. A system for data gathering, comprising
a common data warehouse,
a plurality of event sources, for each event source upon occurrence of an event at said event source, said event source for transmitting a message to said common data warehouse.

8. The data consolidation system of claim 7, wherein said event source comprises:
an event repository for receiving said events;
an event transmitter for transmitting said message; and
an event activator adapted to be activated upon said receiving of said event, and upon said activation, for evaluating search conditions.

9. An event source in an event driven environment, the event source comprises:
an event repository for receiving said events;
an event transmitter for transmitting said message; and
an event activator, wherein upon said receiving of said event, said event activator for causing said transmitter to transmit said message.

10. The event source of claim 9, wherein said event activator comprises:
a trigger for evaluating said search conditions; and
a user-defined function for causing said event transmitter to transmit said event when said search conditions are true.

11. The event source of claim 10, and further comprising:
a subscriber for communicating to said event activator one or more subscriber selectors, said subscriber selectors to be the basis for search conditions.

12. The event source of claim 10, wherein said user-defined function is adapted to implement message oriented middleware (MOM) publisher interface, thereby publishing said messages.

13. The event source of claim 9, and further comprising a software management system for inserting said events in said event repository.

14. A method for gathering data in a event driven environment, the method comprising the steps of:
upon occurrence of an event in an event source, receiving said events in a event repository; and
transmitting an event message to a data warehouse.

15. The method of claim 14, and further comprising the step of:
upon said receiving of said events, activating an event activator for causing an event transmitter to transmit said event message.

16. The method of claim 15, and further comprising the steps of:
evaluating search conditions; and
when said search conditions are true, causing said event transmitter to transmit said event message.

17. The method of claim 15, and further comprising the steps of:
communicating to said event activator one or more subscriber selectors, said subscriber selectors to be a basis for search conditions.

18. The method of claim 14, and further comprising the steps of:
receiving in a consolidator said events from said event transmitter;
consolidating said events;
identifying one or more events of interest; and
allowing said events of interest to be transmitted to a data warehouse.

19. A computer program embodied on a computer-readable medium, the computer program comprising:
a first code segment for receiving one or more events in an event repository;
a second code segment for transmitting an event message to a data warehouse; and
a third code segment, upon receiving of said event, causes said transmission of said message.

20. The computer program of 19, and further comprising:
a fourth code segment for evaluating search conditions; and
a fifth code segment for causing an event transmitter to transmit said event message when said search conditions are true.

21. A method for providing data gathering services in an event driven environment, the method comprising the steps of:
upon occurrence of an event in an event source, receiving said events in a event repository for; and
transmitting an event message to a data warehouse.

22. The method of claim 21, and further comprising the step of:
upon said receiving of said events, activating an event activator for causing an event transmitter to transmit said event message.

23. The method of claim 22, and further comprising the steps of:
evaluating search conditions; and
when said search conditions are true, causing said event transmitter to transmit said event message.

24. A system for providing services for gathering data in an event driven environment, the system comprises:
means for receiving, upon occurrence of one or more events in an event source, said events in a event repository; and
means for transmitting an event message to a data warehouse.

25. The system of claim 24, and further comprising:
means for activating, upon said receiving of said events, an event activator for causing an event transmitter to transmit said event message.

26. The system of claim 25, and further comprising:
means for evaluating search conditions; and
means for causing, when said search conditions are true, said event transmitter to transmit said event message.
